(19) United States
(12) Patent Application Publication
(10) Pub. No.: US 2009/0126845 A1
(43) Pub. Date: May 21, 2009

(54) SILOXANE MODIFIED ELASTOMERS

(76) Inventors: Terrence E. Hogan, Akron, OH (US); Christopher G. Robertson, Akron, OH (US); Sheel P. Agarwal, Stow, OH (US); Mark W. Smale, Hudson, OH (US); Zhong-Ren Chen, Stow, OH (US); Hiroshi Mouri, Tokyo (JP)

Correspondence Address: BRIDGESTONE AMERICAS HOLDING, INC., 1200 FIRESTONE PARKWAY, AKRON, OH, 44317, US

(21) Appl. No.: 11/940,475

(22) Filed: Nov. 15, 2007

(51) Int. Cl. B60C 1/00; C08G 77/00; B32B 25/04

(52) U.S. Cl. 152/525; 428/500; 428/492; 428/447; 528/35; 524/588; 427/387

(57) ABSTRACT

The present invention relates to coating compositions for use on the surface of elastomeric articles and materials. The compositions are useful in the manufacture of rubber goods such as tires.

### FIELD OF THE INVENTION

The present invention relates to coating compositions for use on the surface of elastomeric articles and materials.

### BACKGROUND OF THE INVENTION

Tires, hoses, air springs and other articles of manufacture that comprise rubber are often subject to potentially degradative environmental elements such as heat, light, oxygen, ozone solvents, oils, and/or fuels. It is therefore desirable to provide rubber articles that are resistant to such elements. One method of providing such rubber articles is by application of a coating to the exposed surfaces of such articles. These rubber articles may be subject to flexing, bending, etc., and therefore it is desirable that the coating be flexible, in addition to having good adhesion to the surface of the rubber article.

U.S. Pat. No. 6,777,026 discloses a protective coating for the surfaces of elastomeric articles and materials comprising a functionalized hydrogenated nitrile rubber, a curing component containing an isocyanate group, and a solvent.

There remains, however, a need for coatings that protect rubber articles from exposure to potentially degradative environmental elements, and processes for the application of the same.

### SUMMARY OF THE INVENTION

The present disclosure, in a first embodiment, relates to a rubber article. Such rubber article is characterized by having a surface comprising an unsaturated elastomeric material and a coating covalently bonded thereto, comprising a saturated polymer. In certain embodiments, the rubber article is a tire, air spring or hose.

In another embodiment, the present disclosure relates to a polymeric coating comprising a saturated polymer having the following formula I:

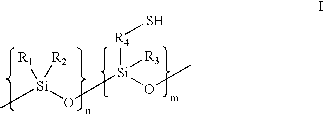

wherein R₁, R₂ and R₃ is independently a monovalent organic group and each R₄ is a divalent organic group, and wherein m and n are integers and the ratio of m to (m+n) is from about 0.03 to about 0.08.

The monovalent organic group includes hydrocarbyl groups such as but not limited to alkyl, cycloalkyl, substituted cycloalkyl, alkenyl, cycloalkenyl, substituted cycloalkenyl, aryl, allyl, substituted aryl, aralkyl, alkaryl, and alkynyl groups, with each group preferably containing from 1 carbon atom, or the appropriate minimum number of carbon atoms to form the group, up to 20 carbon atoms. These hydrocarbyl groups may contain heteroatoms such as, but not limited to, nitrogen, oxygen, silicon, sulfur, and phosphorus atoms.

The divalent organic group includes a hydrocarbylene group or substituted hydrocarbylene group such as, but not limited to, alkylene, cycloalkylene, substituted alkylene, substituted cycloalkylene, alkenylene, cycloalkenylene, substituted cycloalkenylene, substituted cycloalkenylene, arylene, and substituted arylene groups, with each group preferably containing from 1 carbon atom, or the appropriate minimum number of carbon atoms to form the group, up to about 20 carbon atoms. A substituted hydrocarbylene group is a hydrocarbylene group in which one or more hydrogen atoms have been replaced by a substituten such as an alkyl group. The divalent organic groups may also contain one or more heteroatoms such as, but not limited to, nitrogen, oxygen, boron, silicon, sulfur and phosphorous atoms.

In another embodiment, the present disclosure relates to a method of applying a coating to a rubber article, whereby the coating is covalently bonded to the rubber article.

### DETAILED DESCRIPTION OF THE INVENTION

The present invention provides coated rubber articles that are resistant to environmental elements, particularly oxidation, such articles comprising a structure including a surface formed from an unsaturated elastomeric material, and a coating comprising a saturated polymer, wherein the coating is covalently bonded to the outer surface of the elastomeric material.

The rubber articles of the present invention include tires, gaskets, air springs, printing rollers, hoses, belts or components of footwear. In one embodiment, the rubber article of the present invention is a tire, and in another embodiment is a tire sidewall and/or tread. In a further embodiment, the rubber article is an air spring.

Suitable unsaturated elastomeric materials include hydrocarbon rubbers such as natural rubber, styrene-butadiene rubber, butyl rubber, polybutadiene rubber, polyisoprene rubber, terpolymers of ethylene, propylene and a diene monomer, and any combinations thereof.

The saturated polymers of the present disclosure include non-friable, film-forming “rubber-like” polymers which are capable of flexing and stretching in conjunction with rubber articles without cracking or peeling. In one embodiment of the invention, these “rubber-like” saturated polymers have glass transition temperatures (Tg) below the temperature of intended use of the coated articles. In another embodiment, the Tg of the saturated polymers is less than 0° C., in another embodiment less than −30° C., and in a further embodiment less than −50° C.

In one embodiment, the saturated polymer is fully saturated, having about 0 weight % double-bond content. In another embodiment, the double-bond content of the saturated polymer is less than 0.5 weight %, alternatively less than 0.1 weight %, and alternatively less than 0.05 weight %.

Suitable saturated polymers have a number average molecular weight (Mn) of less than 40,000 g/mol, alternatively less than 30,000 g/mol, and alternatively less than 20,000 g/mol. In another embodiment, the molecular weight of the saturated polymer is less than about 4 times, alternatively less than about 3 times, or alternatively less than about 2 times the entanglement molecular weight.

The saturated polymers of the present disclosure include functional siloxane polymers, and in another embodiment such siloxane polymers contain mercapto-functionalization. Mercapto-functionalized siloxane polymers include those of formula I:

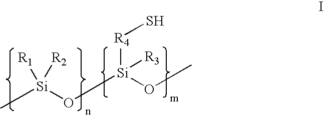

wherein R₁, R₂ and R₃ is independently a monovalent organic group and each R₄ is a divalent organic group, and wherein m and n are integers and the ratio of m to (m+n) is from about 0.03 to about 0.08.

The monovalent organic group includes hydrocarbyl groups such as but not limited to alkyl, cycloalkyl, substituted cycloalkyl, alkenyl, cycloalkenyl, substituted cycloalkenyl, aryl, allyl, substituted aryl, aralkyl, alkaryl, and alkynyl groups, with each group preferably containing from 1 carbon atom, or the appropriate minimum number of carbon atoms to form the group, up to 20 carbon atoms. These hydrocarbyl groups may contain heteroatoms such as, but not limited to, nitrogen, oxygen, silicon, sulfur, and phosphorus atoms.

The divalent organic group includes a hydrocarbylene group or substituted hydrocarbylene group such as, but not limited to, alkylene, cycloalkylene, substituted alkylene, substituted cycloalkylene, alkenylene, cycloalkenylene, substituted cycloalkenylene, substituted cycloalkenylene, arylene, and substituted arylene groups, with each group preferably containing from 1 carbon atom, or the appropriate minimum number of carbon atoms to form the group, up to about 20 carbon atoms. A substituted hydrocarbylene group is a hydrocarbylene group in which one or more hydrogen atoms have been replaced by a substituten such as an alkyl group. The divalent organic groups may also contain one or more heteroatoms such as, but not limited to, nitrogen, oxygen, boron, silicon, sulfur and phosphorous atoms.

Suitable mercapto-functionalized polysiloxanes include poly(dimethyl siloxane-co-mercaptopropylmethylsiloxane) (PDMS) and dimethoxy mercapto propyl terminated siloxanes.

Without being bound by theory, it is believed that the mercapto-functionalized polysiloxanes undergo free radical initiation, and subsequently the mercaptyl radical(s) reacts with the unsaturated site(s) in the elastomeric materials of the rubber article. Through this reaction, at least some of the siloxane chains are covalently bonded to the rubber and are presumed to be non-migrating. Alternatively, some of the mercaptyl radicals in the coating composition may self-couple, forming a highly cross-linked siloxane network. The amount of covalent bonding and/or self-coupling is dependent upon several conditions, including the surface area and amount of unsaturation of the rubber article, the amount of free radicals in the coating and the overall reaction conditions.

The coating compositions may optionally contain a solvent such as C₅-C₈ hydrocarbons, ketones, ethers or esters. In one embodiment, the coating composition of the present disclosure has a viscosity of less than 15,000 cps, alternatively less than 12,000 cps, and alternatively less than 10,000 cps.

Optionally, the coating compositions may contain other additional additives, including fillers, colorants and/or surfactants. Suitable fillers include carbon black, silica, mica, clay, graphite, mineral oxides and the like. The use of such additives may beneficially reduce electrostatic build-up and/or provide gloss benefits to a tire or other rubber article. In one embodiment, the coating composition contains less than 20 weight % carbon black, alternatively less than 10 weight % carbon black, and alternatively less than 5 weight % carbon black.

The coating compositions of the present disclosure may optionally contain a free radical initiator. Suitable free radical initiators are described in the Polymer Handbook, 4^{th} Edition, Editors: J. Brandrup, E. H. Immergut, F. A. Grulke, John Wiley and Sons, New York, 1999, pp. 1-76. In one embodiment, the free radical initiator is peroxide. Such free radical initiators may be pre-dissolved in the saturated polymer and/or coating composition. Optionally, heat may be applied to initiate the free radical reaction.

Alternatively, the free radical reaction may be initiated by exposure of the coating to ultra-violet (UV) light. Typically, UV initiation is conducted in the presence of a UV cure additive as described in the Polymer Handbook, Ibid, pp. 169-176.

The application of the coatings to the surfaces of the rubber articles may be carried out by any of the known methods including spraying, dipping, gravure printing, curtain coating, wiping, brushing, knife over roll and roll over roll.

In one embodiment, the coating is sprayed onto the rubber article such that a uniform, continuous film is deposited onto the surface of the article. In one embodiment, the thickness of the resulting film is less than about 50 μm, alternatively less than about 25 μm, and alternatively less than about 10 μm.

If the coating contains a solvent, heat may be applied to the coated article to evaporate the solvent. Alternatively, such evaporation may occur at room temperature.

In one embodiment, the coating of the present disclosure is applied to a rubber article that has been cured. Alternatively, the coating could be applied to a rubber article prior to cure. If application of the coating is prior to curing of the rubber article, the viscosity of the coating may need to be adjusted to ensure that it does not flow away from the surface during the curing process, and/or such curing may occur in the absence of pressure (ie. molding).

The coating may be applied to part or all of the exposed surfaces of a rubber article. In one embodiment, the coating is applied to a tire, in another embodiment the coating is applied to a tire sidewall, in another embodiment the coating is applied to an air spring.

### EXAMPLES

### Examples 1-4

A solution of 50 wt % polymer, 0.5 wt % lauroyl peroxide, and 49.5 wt % pentane was made for each of the polymers described in the Table 1 below. Using the compound formula of Table 2 below, 7.62 cm×15.24 cm×0.25 cm samples of rubber were prepared and cured for approximately 15 minutes at a temperature of approximately 165° C. Each solution was then sprayed onto one side of a cured sheet which had previously been cleaned with an acetone wetted rag, resulting in a thin film on the surface of the stock. The film added 0.1 g of weight to the cured sheet. The treated sheets were then cured at 120° C. for 20 minutes. Of the four polymers examined, only the SMS-042 containing coating resulted in a clear film. The coating compositions containing polymers having higher levels of mercapto groups, PS850 and PS849, over-cured and formed a brittle wax on the rubber surface that adhered poorly. The coating composition comprising the polymer with lower level of mercapto groups, SMS022, did not cure onto the rubber sample.

TABLE 1

| | | | | MOLE % |
|---|---|---|---|---|
| EXAM- | | | MOLECULAR | MERCAPTO |
| PLE | POLYMER | VISCOSITY | WEIGHT | MONOMER |
| 1 | SMS-022¹ | 120-180 | 6000-8000 g/mol | 2-3 |
| 2 | SMS-042¹ | 120-170 | 7200-8000 g/mol | 4-6 |
| 3 | PS850² | 200 | N/A | 5-10 |
| 4 | PS849² | 100-200 | N/A | 20-25 |

¹Gelest, Inc. (Morrisville, PA)
²United Chemical Technologies, Inc. (Bristol, PA)

TABLE 2

| INGREDIENT | AMOUNT (PHR) |
|---|---|
| Natural Rubber | 40 |
| Butadiene Rubber | 60 |
| Carbon Black | 55 |
| Processing Aids | 17.5 |
| Antidegradants | 5.3 |
| Sulfur | 2.1 |
| Zinc Oxide | 2.5 |
| Stearic Acid | 1.5 |
| Other Curatives | 2.8 |

Bars were then cut from sheets of untreated rubber stock, as well as stock treated with the SMS-042 coating composition of Example 2. The samples were bent and clipped lengthwise and over aged at 34° C. in the presence of 150 pphm ozone. After two days, the untreated sample had cracks throughout the surface with some originating from the middle of the surface. The treated sample, however, showed only cracks emanating from the uncoated edges. The samples were further aged, and after 4 and 8 days, the treated sample continued to show cracking at the uncoated edges only.

A rubber sample was also prepared with the SMS-042 coating composition from Example 2 above, wherein the sample was coated on all sides with the coating composition. In this case, the resistance to ozone was much greater. After 2 days and 6 days, at 150 pphm ozone and 34° C., only one crack formed, and this was potentially due to incomplete coverage of the coating on the sample.

To further exemplify the coating composition, coated article and method disclosed herein, a hypothetical experiment is now disclosed. To the coating composition of Example 2 there could be added Monarch 1500 and/or Monarch 1300 carbon blacks (Cabot Corp., Boston, Mass.), and such composition may optionally be ground to a fine suspension. The fine suspension could then be spray coated onto a rubber surface and oven cured.

Other embodiments of the present invention will be apparent to those skilled in the arts from consideration of the specification and practice of the present invention disclosed herein. It is intended that the specification and examples be considered as exemplary only, with a true scope and spirit of the present invention being indicated by the following claims.

What is claimed is:

1. A rubber article comprising: (a) a structure including a surface formed from an unsaturated elastomeric material; and (b) a coating comprising a polymer wherein the coating is covalently bonded to the surface of the elastomeric material.

2. A rubber article according to claim 1, wherein said polymer is saturated.

3. A rubber article according to claim 2, wherein said saturated polymer contains less than 0.5% double bonds.

4. A rubber article according to claim 1, wherein said polymer has a number average molecular weight of less than 40,000 g/mol.

5. A rubber article according to claim 1, wherein said polymer has a Tg of less than 0° C.

6. A rubber article according to claim 1, wherein the elastomeric material is comprised of a hydrocarbon rubber selected from the group consisting of natural rubber, styrene-butadiene rubber, butyl rubber, polybutadiene rubber, polyisoprene rubber, terpolymers of ethylene, propylene and a diene monomer and any combination thereof.

7. A rubber article according to claim 1, wherein said rubber article is a tire, gasket, air spring, printing roller, hose, belt or footwear.

8. A rubber article according to claim 1, wherein said rubber article is a tire comprising a sidewall.

9. A rubber article comprising: (a) a structure including a surface formed from an unsaturated elastomeric material; and (b) a coating comprising a saturated rubber having a double bond content of less than about 0.5 weight percent.

10. The rubber article of claim 9, wherein the saturated rubber comprises a mercapto-functional polysiloxane of the following formula I: 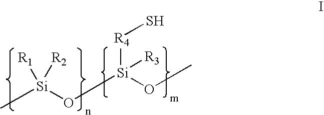
wherein R₁, R₂ and R₃ is independently a monovalent organic group and each R₄ is a divalent organic group, and wherein m and n are integers and the ratio of m to (m+n) is from about 0.03 to about 0.08.

11. The rubber article of claim 9, wherein the mercapto-functional polysiloxane is poly(dimethylsiloxane-co-mercaptopropylmethylsiloxane).

12. A rubber article according to claim 1, wherein the elastomeric material is comprised of a hydrocarbon rubber selected from the group consisting of natural rubber, styrene-butadiene rubber, butyl rubber, polybutadiene rubber, polyisoprene rubber, terpolymers of ethylene, propylene and a diene monomer and any combination thereof.

13. A polymeric coating comprising a mercapto-functional polysiloxane of the following formula: 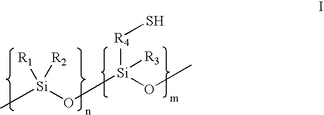
wherein R₁, R₂ and R₃ is independently a monovalent organic group and each R₄ is a divalent organic group, and wherein m and n are integers and the ratio of m to (m+n) is from about 0.03 to about 0.08.

14. The polymeric coating of claim 13, wherein the mercapto-functional polysiloxane is poly(dimethylsiloxane-co-mercaptopropylmethylsiloxane).

15. The polymeric coating of claim 13, further comprising a free radical initiator.

16. The polymeric coating of claim 13, further comprising a filler.

17. A polymeric coating comprising a saturated polymer having a double bond content of less than about 0.5 weight percent and a Tg of less than about 0° C.

18. The polymeric coating of claim 17, wherein the saturated polymer has a Mn of less than about 40,000 g/mol.

19. The polymeric coating of claim 17, wherein the saturated polymer has a molecular weight of less than about four times the entanglement molecular weight.

20. The polymeric coating of claim 17 further comprising a free radical initiator, and optionally a solvent.

21. A method of coating a rubber article comprising the steps:
a) providing a cured rubber article having at least a portion of a surface comprising an elastomeric material;
b) applying to the surface a coating comprising a mercapto-functional polysiloxane.

22. The method of claim 21 wherein the coating further comprises a free radical initiator and optionally a solvent.

23. The method of claim 22 further comprising the step of heating the coated surface.

24. The method of claim 21, wherein the mercapto-functional polysiloxane has the formula: 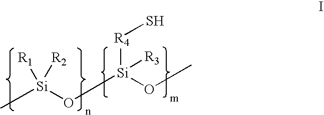
wherein R₁, R₂ and R₃ is independently a monovalent organic group and each R₄ is a divalent organic group, and wherein m and n are integers and the ratio of m to (m+n) is from about 0.03 to about 0.08.

25. The method of claim 21 wherein the coating has a viscosity of less than or equal to about 15,000 cps.

26. The method of claim 21, wherein the rubber article is a tire.

27. The method of claim 26, wherein the coating is applied to the sidewall portion of a tire.

28. The method of claim 21, wherein said coating is applied by spraying.
